(19) United States
(12) Patent Application Publication
(10) Pub. No.: US 2015/0200055 A1
(43) Pub. Date: Jul. 16, 2015

(54) LAMINATE-TYPE CERAMIC ELECTRONIC COMPONENTS

(71) Applicant: TDK CORPORATION, Tokyo (JP)

(72) Inventors: Keisuke ISHIDA, Tokyo (JP); Koichi YAMAGUCHI, Tokyo (JP); Makoto ENDO, Tokyo (JP); Shimpei TANABE, Tokyo (JP)

(21) Appl. No.: 14/592,718

(22) Filed: Jan. 8, 2015

(30) Foreign Application Priority Data
Jan. 14, 2014 (JP) 2014-004030
Oct. 22, 2014 (JP) 2014-215625

(51) Int. Cl. H01G 4/12; H01G 4/01; H01G 4/30

(52) U.S. Cl. CPC H01G 4/1218; H01G 4/30; H01G 4/01

(57) ABSTRACT

The present invention is aimed to improve the poor insulation of the laminate-type ceramic electronic component having dielectric ceramic layers of 0.5 μm or less. A laminate-type ceramic electronic component which is a laminated body having a laminated structure formed by laminating the first ceramic parts and the internal electrode layers alternately. The first ceramic parts have a main ingredient of ABO₃ representing a perovskite-type crystal in which site A contains at least Ba and site B contains at least Ti. The laminate-type ceramic electronic component has external electrodes which are connected with the internal electrodes. The end edge parts of the internal electrodes other than the end connected with the external electrodes are connected with the second ceramic parts. The second ceramic parts contain aluminum oxide as a main ingredient.

The present invention relates to a laminate-type ceramic electronic component formed by laminating internal electrode layers and ceramic layers alternately.

### BACKGROUND

In recent years, accompanying with the progressing of miniaturization and thinning of the electronics, the electronic components mounted in these electronics are also required to be compact. Specifically, as for laminated ceramic capacitors, a large capacity in a compact product is required due to the limitation of the mounting area of the electronic components according to the needs of the thin-type consumer equipments.

For the requirements of the market, the laminated ceramic capacitor should be ensured in the capacity and should be miniaturized. Herein, the electrostatic capacity of the laminated ceramic capacitor is expressed by Formula 1.

$$C = ( \frac{{ɛ}_{r} \times {ɛ}_{0} \times S}{d} ) \times n \qquad ( Formula 1 )$$

C: electrostatic capacity, ∈ᵣ: relative permittivity, ∈₀: vacuum permittivity,
S: overlapping area of the internal electrodes,
d: thickness of the dielectric ceramic layer,
n: number of the laminated layers

It is known from Formula 1 that, in the increase of the requirements for miniaturization, the laminated ceramic capacitor may be adjusted by improving the inherent relative permittivity of the ceramic materials, thinning the thickness of the dielectric ceramic layers, increasing the number of the laminated layers by thinning the thickness of layer of the internal electrodes, etc. in order to improve the static capacity of the laminated ceramic capacitor in the consideration of the determined shape and size and the overlapping area of the internal electrodes.

However, since the relative permittivity is an inherent value of a material, a great improvement cannot be anticipated unless a new dielectric material is found. Therefore, a study is needed on the designs such as thinning the thickness of the internal electrode layer or the thickness of the dielectric ceramic layer. In recent years, a laminated ceramic capacitor forming with internal electrode layers and dielectric ceramic layers of 0.5 μm or less is demanded. However, problems of short-circuit failure or poor insulation will occur accompanying with the layer-thinning of the internal structures.

Patent document 1 has proposed a method, in which an end edge parts of the internal electrodes located in the laminated body are connected to second ceramic parts of CaZrO₃, thereby the end parts of the internal electrode layers are covered by CaZrO₃ due to the high wettability of CaZrO₃ with Ni of the internal electrode layers, midway disconnecting or spheroidizing of electrode in the end edge parts of the internal electrode layers is inhibited and it is not easy to cause a reduction of dielectric strength, and thus the breakdown electric field strength is improved.

### PATENT DOCUMENTS

Patent document 1: JP2008-016706

### SUMMARY

However, in the structure proposed in patent document 1, the second ceramic parts of CaZrO₃ are repeatedly printed with respect to the slope of the printing drip part in the end parts of the internal electrode layers to inhibit a spheroidizion caused by the wettability of material with the internal electrode layer of Ni. But Ni particles of the end parts will be spheroidized before an internal electrode layer is wetted by CaZrO₃ because the starting sintering temperature of CaZrO₃ is higher than that of Ni particles of the internal electrode layer, and thus it is not sufficient to inhibit the decreasing of insulating resistance in a process of layer-thinning in which the dielectric ceramic layer is thinned to be 0.5 μm or less.

Herein, the present invention aims to inhibit the occurring of poor insulation and improve the breakdown electric field strength even in the case in which the internal electrode ingredient of the end parts of the internal electrode layer is disconnected midway and spheroidized in the laminate-type ceramic electronic component having dielectric ceramic layers of 0.5 μm or less.

In order to solve the technical problem mentioned above, the laminate-type ceramic electronic component of the present invention which is a laminated body having a laminated structure formed by laminating first ceramic parts comprising ABO₃ (representing a perovskite-type crystal in which site A contains at least Ba and site B contains at least Ti) as a main ingredient and internal electrode layers alternately, and has external electrodes which are connected with the internal electrodes, wherein the end edge parts of the internal electrode layers other than the end connected with the external electrode are connected with the second ceramic parts, and the second ceramic parts contain aluminum oxide as a main ingredient.

That is, the laminated body mentioned above has first ceramic parts composed of perovskite-type crystal ceramic of ABO₃ and second ceramic parts containing aluminum oxide as the main ingredient, and the end edges of the internal electrodes located in the laminated body are connected with the second ceramic parts.

Herein, the state in which the end edge parts of the internal electrode layers are connected with the second ceramic parts preferably refers to a state in which internal electrode ingredients formed with a midway disconnection and a spheroidization of internal electrode layer parts are sandwiched by the second ceramic parts in the thickness direction.

In addition, the first ceramic parts are the parts possessing a function as a laminate-type ceramic electrode component, and the second ceramic parts have a function for improving the reliability of the laminate-type ceramic electrode component.

Further, the second ceramic parts are parts which can become step absorbing layers after various components diffuse during the processes of binder removal, firing and reoxidizing of the green bodies containing organics which are printed and laminated, in the manufacturing process of the laminate-type ceramic electronic component.

In the laminate-type ceramic electronic component of the present invention, the second ceramic parts using alumina as a main ingredient are connected with the end parts of the internal electrode layers. Since the combination of alumina with oxygen is very strong, the laminated ceramic capacitor and the like will not produce oxygen defects easily when it is fired in a reducing atmosphere with a partial pressure of oxygen of about 10⁻¹¹ atm. Therefore, the behavior as a semiconductor will not occur due to the oxygen defeats and has a high resistance, and thus even if the internal electrode ingredient of the ends of internal electrode layers is spheroidized and the thickness of the dielectric ceramic layer near the end part of the internal electrode layer is thinner than the target thickness, the poor insulation can be inhibited greatly.

In addition, the laminate-type ceramic electronic component of the present invention wherein the content of Al contained in the second ceramic parts is in a range of 40 mol % or more and 80 mol % or less in the metal elements constituting the second ceramic parts, and at least one of the elements selected from the group consisting of Si, Ti, Zr, Ce, Ba, Ca, Y, and Mg is contained as the auxiliary ingredients.

In the elements constituting the second ceramic parts, if the content of Al is less than 40 mol %, the ratio of alumina which is a main ingredient decreases, and thus the rates of poor insulation increases. In addition, if the content of Al exceeds 80 mol %, the alumina tends to react with the dielectric ceramic particles in the dielectric layer and thus it is not preferable.

By setting the content of Al contained in the second ceramic part in the ranges mentioned above, even if the end part of the internal electrode layer is spheroidized and the dielectric ceramic layer and the second ceramic part are thinner than the target thickness, since the second ceramic part has Al as a main ingredient, poor insulation can be greatly improved.

In addition, by containing at least one of elements selected from the group consisting of Si, Ti, Zr, Ce, Ba, Ca, Y, and Mg as the auxiliary ingredients, the alumina which is difficult to be sintered may be sintered.

The laminate-type ceramic electronic component of the present invention wherein the Si which is contained as the auxiliary ingredient of the second ceramic parts is contained in a range of 10 mol or more and 90 mol or less relative to 100 mol of the main ingredient of Al.

If the content of Si is less than 10 mol, glass ingredients at the grain boundary of the sintered ceramic particles are decreased and the good breakdown electric field strength cannot be maintained. Further, if the content of Si exceeds 90 mol, the ratio of alumina which is a main ingredient decreases and the rates of poor insulation increases.

By containing raw materials of Si in such a range, the alumina which is difficult to be sintered can be sintered under the sintering temperature of the first ceramic part even if alumina is used as the main ingredient. Also, the improvement of poor insulation and good breakdown electric field strength can be maintained.

According to the present invention, in the laminate-type ceramic electronic component with dielectric ceramic layers of 0.5 μm or less, the occurrence of product with poor insulation may be inhibited and the breakdown electric field strength may be improved even in the case in which the internal electrode ingredient of the end parts of the internal electrode layers is disconnected midway and spheroidized.

### BRIEF DESCRIPTION OF THE DRAWINGS

FIG. 1 is a schematic sectional view of the laminated ceramic capacitor according to one embodiment of the present invention in which external electrodes can be observed.

FIG. 2 is a schematic sectional view of the laminated ceramic capacitor according to one embodiment of the present invention in which side margins can be observed.

FIG. 3 is a schematic view of a state near the interface between a first ceramic part and a second ceramic part according to one embodiment of the present invention.

FIG. 4 is a schematic sectional view of the green sheet of the capacitor part formed by printing internal electrodes and step absorbing layers, relating to a producing method of the laminated ceramic capacitor according to one embodiment of the present invention.

### DETAILED DESCRIPTION OF EMBODIMENTS

Hereinafter, laminated ceramic capacitors are described as examples for the preferable embodiments of the present invention. The same symbol is imparted to the same components, and the repeated description will be omitted. In addition, the drawings are schematic, and the size ratios between the components or the shapes of the components and the like may be different from the actual ones.

(Laminated Ceramic Capacitor)

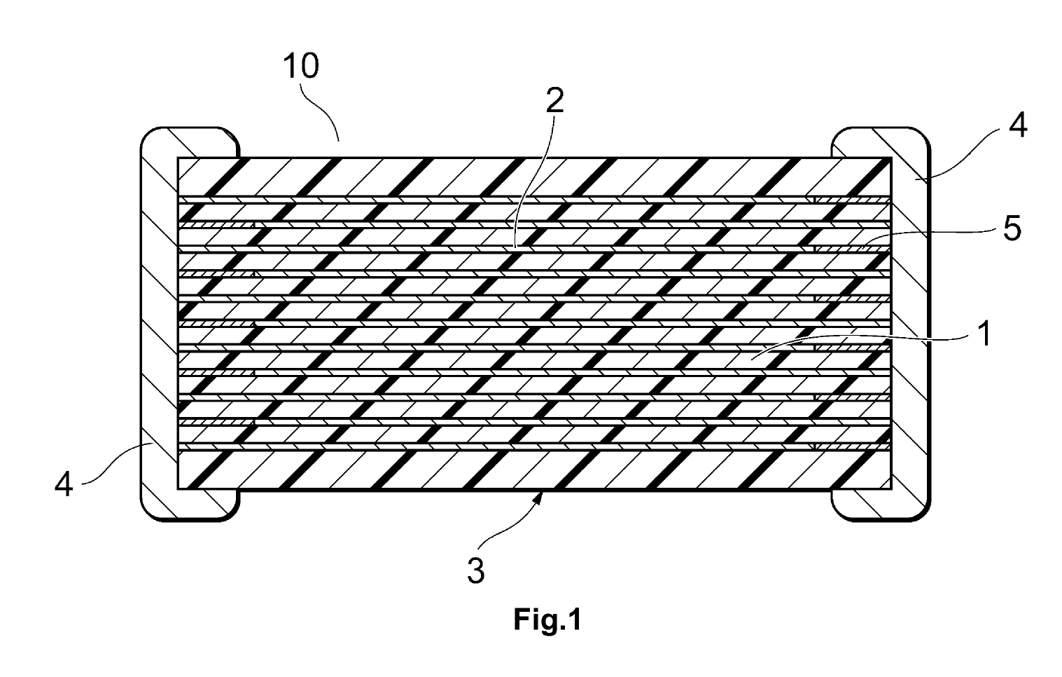

As shown in FIG. 1, a laminated ceramic capacitor 10 according to one embodiment of the present invention is a laminated body 3 which is a structure formed by laminating first ceramic parts 1 and internal electrodes 2 alternately, and has external electrodes 4 connected with the internal electrodes 2. The end edges other than the ends of the internal electrodes 2 connected with the external electrodes 4 are connected with the second ceramic parts 5. The shape of the laminated body 3 is not particularly limited and is usually made to be rectangular. In addition, the size thereof is not particularly limited either, and may be a proper size in accordance with the application.

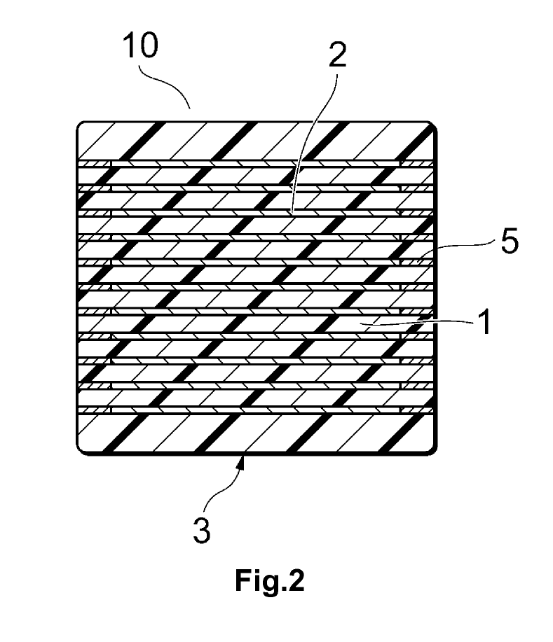

In addition, as shown in FIG. 2, in the schematic sectional view excluding the external electrodes, the end edges of the internal electrode layers 2 located in the laminated body 3 are connected with the second ceramic parts 5 in the laminated ceramic capacitor 10 according to one embodiment of the present invention, and the second ceramic parts are extended to the side surface of the laminated body 3 by which the laminated surfaces of the internal electrode layers 2 are prolonged.

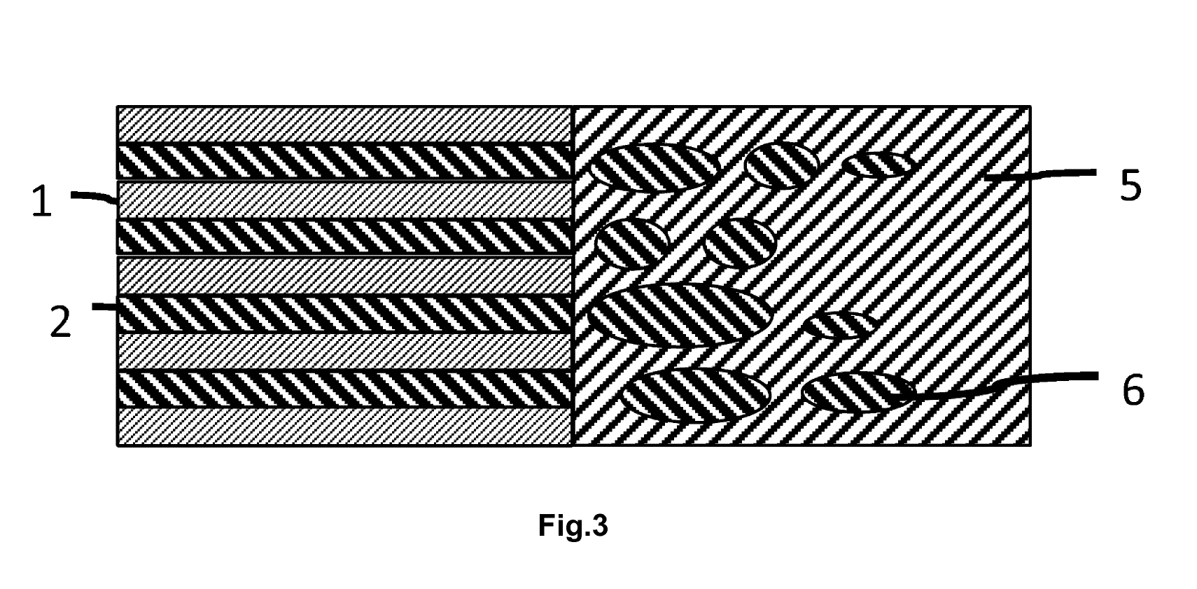

In addition, as shown in FIG. 3, it is preferable that the second ceramic parts are located so as to sandwich the positions of the end parts of the internal electrode layers which are disconnected midway and spheroidized in a thickness direction.

(The Ceramic Composition of the First Ceramic Part)

The composition of the first ceramic part 1 (dielectric ceramic layer) mentioned above are not particularly limited, and it is preferable to be as follow. ABO₃ (representing a perovskite-type crystal in which the site A contains at least Ba and the site B contains at least Ti) is used as the main ingredient. As an auxiliary ingredient, relative to 100 mol of ABO₃, Mg is in a range of 0.01 mol or more and 2.00 mol or less in terms of MgO, the oxide of R (wherein, R is at least one selected from the group consisting of Y, Dy, Ho, Yb, Lu, Gd and Tb) is in a range of 0.20 mol or more and 1.00 mol or less in terms of R₂O₃, SiO₂ is 0.40 mol or more and 2.00 mol or less, the oxide of Mn is more than 0.00 mol and less than 0.50 mol in terms of MnO, and the oxide of V is 0.01 mol or more and 0.50 mol or less in terms of V₂O₅.

(The Ceramic Composition of the Second Ceramic Part)

The content of Al which is a main ingredient of the second ceramic part 5 mentioned above is preferable to be in a range of 40 mol % or more and 80 mol % or less and more preferable to be in a range of 65 mol % or more and 77 mol % or less in the elements constituting the second ceramic part.

In the elements constituting the second ceramic part mentioned above, if the content of Al is less than 40 mol %, the ratio of alumina which is a main ingredient decreases, and thus the rates of poor insulation increases. In addition, if the content of Al exceeds 80 mol %, the alumina tends to react with the dielectric ceramic particles in the dielectric layers and thus it is not preferable.

By setting the content of Al contained in the second ceramic part in the ranges mentioned above, even if the end parts of the internal electrode layers are spheroidized, and the thicknesses of the dielectric ceramic layers and the second ceramic parts are thinner than the target ones, since the second ceramic parts have Al as a main ingredient, poor insulation can be improved greatly.

Further, in the composition of the second ceramic part 5 mentioned above, elements constituting the first ceramic part may be contained through a sintering diffusion from the first ceramic part in the firing process.

The content of Si in the second ceramic part 5 mentioned above is contained in a range of 10 mol or more and 90 mol or less, and more preferably 20 mol or more and 40 mol or less, with respect to 100 mol of Al. As for other auxiliary raw materials, it is preferable to contain at least one element selected from the group consisting of Ti, Zr, Ce, Ba, Y, and Mg, and more preferable to contain two or more elements.

If the content of Si is less than 10 mol, glass ingredients at the grain boundary of the sintered ceramic particles are decreased and the good breakdown electric field strength cannot be maintained. Further, if the content exceeds 90 mol, the ratio of alumina which is a main ingredient decreases and the rates of poor insulation increases.

(Manufacture of a Laminated Ceramic Capacitor)

In manufacturing a laminated ceramic capacitor 10, a laminated body 3 is prepared in a state containing organic components and the like through well-known methods such as preparing a dielectric ceramic paste, preparing a internal electrode paste, preparing the ceramic paste for step absorbing layers, printing, laminating, and cutting. Then the organic components are carbonized and combusted. Binder removal process, firing process and reoxidizing process are carried out in order to sinter the laminated body 3. Subsequently, external electrodes 4 are formed on the end surfaces of the sintered laminated body 3, and thus the laminated ceramic capacitor 10 is completed.

(Dielectric Ceramic Paste)

The paste for the dielectric ceramic layers of the present invention is preferable to use a dielectric ceramic powder with an average particle diameter from 20 nm to 100 nm. With the average particle diameter being in this range, a dense dielectric ceramic green sheet can be prepared.

The dielectric ceramic paste is prepared by the following processes. A dielectric ceramic powder, an auxiliary raw material of oxides or carbonates, and an organic vehicle are mixed by a homomixer in a composition of the first ceramic part mentioned above. After that, the obtained mixture is dispersed and milled in a 3-roll mill, a ball mill or a beads mill to prepare the dielectric ceramic paste.

The organic vehicle mentioned above is obtained by dissolving binder resins in the solvents. The binder resins used in the organic vehicle are not particularly limited, and various ordinary binder resins such as ethyl cellulose, polyvinyl butyral, and acrylic resin and the like may be exemplified.

In addition, solvents used in the organic vehicle are not particularly limited, and ordinary solvents such as water, alcohols, ketones, ethers, esters, alkanes, alkenes, alkynes, cyclealkanes, aromates and the like may be exemplified.

(Internal Electrode Paste)

As for the internal electrode paste of the present invention, the particle diameter of the conductive powder is not particularly limited and preferable to use particles with an average particle diameter ranging from 50 nm to 200 nm. In addition, as a common material, a dielectric ceramic powder added in order to delay the sintering behavior of conductive powders has the same composition as the dielectric ceramic powder used in the dielectric ceramic paste, and it is preferable to use a dielectric ceramic powder having a particle diameter with an average particle diameter ranging from about 10 nm to 50 nm.

The content of the common material is preferably 10% or more and 30% or less relative to the conductive powders. The sintering shrinkage behavior of the internal electrode layer may be controlled by the content of the common material.

As for the conductive powders mentioned above, nickel or nickel alloy, copper or copper alloy, palladium, silver palladium alloy and the like may be exemplified, and nickel, palladium or nickel alloy are preferable.

The paste for the internal electrode is produced by mixing the prepared conductive powders, the dielectric powder and the organic vehicle by a homomixer, and then dispersing and milling the obtained mixture in a 3-roll mill or a ball mill.

The organic vehicle mentioned above is obtained by dissolving binder resins in the solvents. The binder resins used in the organic vehicle are not particularly limited, and various ordinary binder resins such as ethyl cellulose, polyvinyl butyral, and acrylic resin and the like may be exemplified.

The solvents used in the organic vehicle may use the solvents which is obtained by dissolving resins and will not cause problems separating out or saturating the dielectric ceramic green sheet and the like.

(Ceramic Paste for Step Absorbing Layers)

In order to form the second ceramic part in the present invention, ceramic paste for step absorbing layers using an aluminum compound as an inorganic main component is prepared. The aluminum compound is preferably aluminum oxide, boehmite, or aluminum isopropoxide.

Further, as the inorganic auxiliary raw material of the ceramic paste for step absorbing layers, it is preferable to contain at least one of the elements selected from the group consisting of Si, Ti, Zr, Ce, Ba, Ca, Y, and Mg. As the Si raw material, SiO₂, ZrSiO₄, alkoxy silane and silane coupling agent may be exemplified, in which SiO₂, alkoxy silane, and silane coupling agent are preferable.

As the Ti raw material, TiO₂, BaTiO₃, titanium(IV) isopropoxide and the like may be exemplified. As the Zr raw materials, ZrO₂, YSZ (Yttria-Stabilized Zirconia), ZrSiO₄, and zirconium acetylacetonate and the like can be exemplified. As the Ce raw materials, CeO2 may be exemplified. As the Ba raw material, BaCO₃, BaTiO₃, Ba—Ca—Si glass and the like may be exemplified. As the Ca raw material, CaCO₃, CaTiO₃, pantothenic acid calcium, Ba—Ca—Si glass and the like may be exemplified. As the Y raw material, Y₂O₃, YSZ, yttrium acetate and the like may be exemplified. As the Mg raw material, MgO, MgCO₃ and the like may be exemplified.

These auxiliary raw materials are added in order to sinter the alumina of difficult sinterability under the sintering temperature at which the laminated body of the laminated ceramic capacitor is sintered.

Various ceramic powders used in the ceramic paste for the step absorbing layers are preferably tiny particles in the paste, and preferably composed by particles with a particle diameter ranging from 3 nm to 50 nm in terms of a specific surface area.

The ceramic raw material powder for the step absorbing layers which does not fall into the range of the particle diameter mentioned above are preferably to be pulverized by a ball mill, a beads mill and the like so as to fall into the range of the particle diameter.

The ceramic for the step absorbing layers and the electrode paste are prepared by the following processes. A prepared raw material powder, a disperser and an organic solvent are mixed by a homomixer and dispersed in a beads mill to become slurry. Then an organic vehicle is mixed. After that, the organic solvent is vaporized by an evaporator so that the content thereof is within the expected range, and then the obtained mixture is milled in a 3-roll mill.

The organic vehicle mentioned above is obtained by dissolving binder resins in the solvents. The binder resins used in the organic vehicle are not particularly limited, and various ordinary binder resins such as ethyl cellulose, polyvinyl butyral, and acrylic resin and the like may be exemplified.

The solvents used in the organic vehicle may use the solvents which is obtained by dissolving resins and will not cause problems separating out or saturating the dielectric ceramic green sheet and the like.

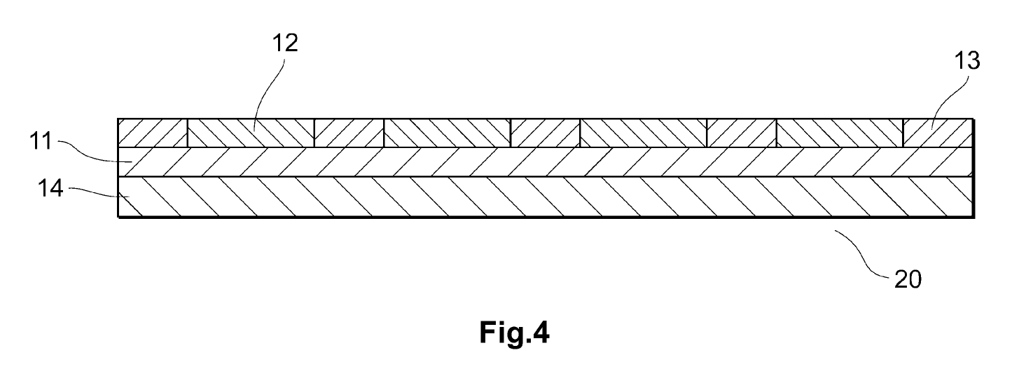

Hereinafter, the manufacturing method of the laminated ceramic capacitor according to the present embodiment is explained with reference to FIG. 1, FIG. 2 and FIG. 4.

The dielectric ceramic paste for forming the first ceramic parts (dielectric ceramic layers), an internal electrode paste for forming the internal electrode layers, and a ceramic paste for the step absorbing layers for forming the second ceramic parts 5 as shown in FIG. 1 and FIG. 2 after being fired are firstly prepared.

First, in order to form the dielectric ceramic green sheet 11 as shown in FIG. 4, a dielectric ceramic green sheet preferably with a thickness of 0.3 μm or more and 0.6 μm or less is formed on the carrier film 14 used as supporting body by a die coating method, a doctor blade method and the like using the dielectric ceramic paste described above.

Next, in order to form the internal electrode green layers 12 as shown in FIG. 4, internal electrode green layers 12 which have a predetermined pattern and preferably a thickness of 0.6 μm or less are formed on the dielectric ceramic green sheet 11 by printing method such as screen printing using the internal electrode paste described above.

Moreover, in order to form the ceramic green layers 13 which are the step absorbing layers as shown in FIG. 4, the ceramic green layers 13 are formed in the concave parts between the internal electrode green layers 12 on the dielectric ceramic green sheet 11 such that it is preferable that the thickness thereof is similarly the same as that of the internal electrode green layers 12 and there is an overlapping of about 10 μm with the internal electrode layer 12 by printing method such as screen printing method, and then are dried. The green sheet obtained as such is called a capacity part green sheet 20 here. Herein, it is preferable to have an overlapping of about 10 μm. If the overlapping is greater than 10 μm, a harmful effect will be brought to the electrical properties other than reliability. If there is no overlapping at all, the content of alumina in the dielectric ceramic layer of the spheroidized part of the internal electrode ingredient will decrease, and thus a great effect cannot be expected and the deviation of high-quality products and defective products will increase.

The carrier film 14 of the capacity part green sheet 20 manufactured as mentioned above is peeled off, an expected number of green sheets of capacity part are laminated, and a green body forming electrostatic capacity in the laminated ceramic capacitor is prepared. Further, in the green sheet formed merely by dielectric ceramic green sheet 11, a structure formed by laminating an expected number of pieces is also prepared in addition, and is hot pressed and bonded on and below the laminated surface of the green body.

Then, the obtained laminated body is cut into single chips. The method for cutting into single chips is not particularly limited, and press-cutting methods, dicing blade method, laser dicing method and the like may be exemplified.

(Binder Removal Process)

The binder removal process is carried out under the conditions in which an oxygen partial pressure is 10⁻²¹ atm or more and 10⁻¹⁶ atm or less, a mixed gas of nitrogen and hydrogen in which concentration of hydrogen is 0.1% or less and 4.0% or more, and the top holding temperature is 650° C. or more and 850° C. or less. The heating rate and the holding temperature are not particularly limited as long as the content of the residual carbon is 0.1 mass % or less. If the binder removal temperature is lowered, a great amount of carbon will escape from the laminated body in the firing process due to the great amount of the residual carbon, and thus delamination will occur easily.

(Firing Process)

As the furnace used in the firing process, for example, an elevator batch type atmosphere firing furnace, a pusher furnace, a belt furnace, a roller hearth kiln, a HIP (Hot Isostatic Pressing) firing furnace and the like may be exemplified.

The firing is for example carried out under the conditions in which the heating rate is 600° C./h or more and 20000° C./h or less, the holding temperature is 1 minute or more and 2 hours or less, the atmosphere is an atmosphere with nitrogen, hydrogen and water vapor coexisting, and the concentration of hydrogen is 0.1% or less and 4.0% or more. If the concentration of hydrogen becomes too high, the carbon remained in the binder removal process will still remain in the firing process and the condition for reoxidation will be shifted to a higher temperature, and thus it is not preferable. On the other hand, if the concentration of hydrogen is lowered, the conductive powder will be probably oxidized, and thus it is not preferable.

(Reoxidizing Process)

The fired laminated body sintered under such a condition is treated with a reoxidation. The reoxidizing process is carried out in an atmosphere with nitrogen and water vapor coexisting in which the oxygen partial pressure is controlled to be 10⁻⁸ atm to 10⁻⁴ atm. In addition, the holding temperature is preferably in a range of 800° C. to 1050° C. If the holding temperature during the reoxidizing process is lower than the temperature range described above, the reoxidizing of the dielectric materials will not be performed sufficiently, and thus the insulation resistance and the life characteristic may be decreased.

For the laminated body 3 (a sintered body chip) obtained as mentioned above, for example, a polishing of an end surface is performed by barrel polishing, sand blasting and the like, the paste for external electrodes is fused and the external electrodes 4 is formed, thereby the laminated ceramic capacitor 10 is formed.

Hereinbefore, the embodiments of the present invention are explained. The present invention mentioned above is not limited by the embodiments mentioned above and can be applied by making changes in various way within the range not deviating from the gist of the present invention.

### Examples

Hereinafter, the present invention is further described based on the detailed examples. However, the present invention can make changes in various ways within the range not deviating from the purpose of the present invention.

(Dielectric Ceramic Powder)

BaCO₃, CaCO₃, TiO₂, and ZrO2 were used in the raw materials mingled respectively so as to make an element ratio of Ba:Ca being 96:4 and Ti:Zr being 94:6. After being fired in the atmosphere under 700° C., they were pulverized by a beads mill and (Ba,Ca)(Ti,Zr)O₃ particles of 50 nm were obtained.

In addition, an auxiliary raw material was prepared with a composition in which, Mg was 0.1 mol, Mn was 0.2 mol, V was 0.1 mol, Y was 0.8 mol, Si was 1.3 mol, Ba was 0.7 mol, and Ca was 0.5 mol relative to 100 mol (Ba,Ca)(Ti,Zr)O₃ mentioned above. As the raw material, Mg in the form of MgO, Mn in the form of MnCO₃, V in the form of V₂O₅, Y in the form of Y₂O₃, and Si, Ba, Ca in the forms of SiO₂, BaCO₃, CaCO₃ were mixed, pulverized and prefired to be prepared as glass tiny powders.

(Manufacturing of a Dielectric Ceramic Paste)

First, in order to form the dielectric green sheet for constituting the dielectric ceramic layers, a paste for dielectric ceramic layers was manufactured by the following method using the dielectric ceramic powder mentioned above.

The dielectric ceramic powder was mixed into a solvent which was obtained by mixing organic solvents such as alcohols, ketones, alkanes and the like and dispersers. Then the mixture was mixed and stirred by a homomixer to become slurry and then was pulverized and mixed using zirconia beads of φ0.5 mm for 16 hours.

An organic vehicle is thrown into the slurry mentioned above and mixed by a homomixer, and then the mixture was pulverized and mixed using zirconia beads of φ2.0 mm for 24 hours, thereby the paste for dielectric ceramic layers was prepared.

The organic vehicle mentioned above was prepared by dissolving poly (vinyl butyral) in a mixed solvent of ethanol, 2-propanol, methyl ethyl ketone, mineral spirit, and xylene with a homomixer.

(Inorganic Powder for Ceramic Paste of the Step Absorbing Layers)

Various raw materials were used to prepare substances with mole ratios as shown in table 1. The raw materials used Boehmite (Al₂O₃.H₂O), tetraethoxysilane (TEOS), zirconium oxide (ZrO₂), titanium dioxide (TiO₂), barium titanate (BaTiO₃), calcium titanate (CaTiO₃), cerium oxide (CeO₂), yttrium oxide (Y₂O₃), magnesium oxide (MgO) respectively.

| | Al₂O₃•H₂O | TEOS | ZrO₂ | TiO₂ | BaTiO₃ | CaTiO₃ | CeO₂ | Y₂O₃ | MgO |
|---|---|---|---|---|---|---|---|---|---|
| | mol | mol | mol | mol | mol | mol | mol | mol | mol |
| Sample 1 | 100 | 9 | 5 | | 2 | 1 | | | |
| Sample 2 | 100 | 9 | 2 | 5 | 5 | 5 | 2 | 2 | 1 |
| Sample 3 | 100 | 42 | | | 2 | 1 | | | 1 |
| Sample 4 | 100 | 21 | 2 | 5 | 10 | 6 | | | |
| Sample 5 | 100 | 46 | | 2 | 3 | 3 | | | |
| Sample 6 | 100 | 55 | | | | | | | 10 |
| Sample 7 | 100 | 40 | | | 10 | 6 | | | 12 |
| Sample 8 | 100 | 50 | 20 | 10 | 10 | | 1 | 2 | |
| Sample 9 | 100 | 80 | 3 | 2 | 5 | 4 | | | 2 |
| Sample 10 | 100 | 35 | 10 | | 25 | 10 | | | |
| Sample 11 | 100 | 50 | 25 | | 10 | 6 | 5 | 1 | 5 |
| Sample 12 | 100 | 87 | | 8 | 15 | 12 | | | |
| Sample 13 | 100 | 65 | 20 | | 20 | 12 | | 2 | 10 |
| Sample 14 | 100 | 100 | 40 | 40 | 20 | 10 | | 2 | 20 |
| Sample 15 | 100 | 182 | 20 | 40 | 20 | 10 | | | |
| Sample 16 | 100 | 50 | 30 | 40 | 50 | 40 | | | 10 |
| Sample 17 | 100 | 18 | 50 | 50 | 50 | 40 | 3 | 2 | 20 |
| Sample 18 | 100 | 188 | 20 | 40 | 20 | 10 | | | |
| Sample 19 | 100 | 58 | 50 | 50 | 50 | 40 | 3 | 2 | 10 |

(Manufacturing of a Ceramic Paste for the Step Absorbing Layers)

The ceramic raw materials for the step absorbing layers as shown in table 1 were mixed with the methyl ethyl ketone solvent in which dispensers were dissolved. After being mixed and stirred by a homomixer to become slurry, the mixture was then pulverized and mixed using zirconia beads of φ0.5 mm for 24 hours.

Then, an organic vehicle was added into the slurry mentioned above and then the mixture was pulverized and mixed using zirconia beads of φ0.5 mm for 24 hours. After that, the organic vehicle was vaporized by an evaporator to adjust the inorganic concentration. Then the mixture was milled in a 3-roll mill and thereby the ceramic paste for the step absorbing layers was prepared.

The organic vehicle mentioned above was prepared by dissolving polyvinyl butyral and ethyl cellulose into the mixed solvent of terpineol and methyl ethyl ketone.

(Manufacturing of the Internal Electrode Paste)

Nickel powders (with an average particle diameter of 150 nm), (Ba,Ca)(Ti,Zr)O₃ based dielectric ceramic powders with an average particle size of 30 nm which is the composition of the dielectric ceramic powder mentioned above, and the organic vehicle were prepared.

Nickel powders, dielectric ceramic powders of 30 nm, and the organic vehicle were mixed by a homomixer and then were dispersed by an ultrasonic homomixer for 30 minutes.

Subsequently, the solvent was evaporated by an evaporator to a certain extent to make the concentration of the inorganic solid content in the paste be 40 mass %, and then was milled in a 3-roll mill to adjust the viscosity and prepared.

(Manufacturing of the Laminated Capacitor)

First, the paste for the dielectric ceramic layers, the ceramic paste for the step absorbing layers, and the internal electrode paste were prepared.

A dielectric ceramic green sheet was formed on the carrier film used as supporting body by slot die coating method using the paste for the dielectric ceramic layers described above.

Subsequently, in order to form the internal electrode layers, internal electrode layer patterns were formed on the dielectric ceramic green sheet by screen printing using the internal electrode paste mentioned above.

Further, the ceramic paste for the step absorbing layers described above was screen-printed in the concave parts between the internal electrode patterns and then was dried. The capacity part green sheet was thus prepared.

In addition, being separated from the capacity part green sheet, a green sheet for the outer layer was prepared in which only a dielectric ceramic green sheet was formed on the carrier film.

Then, the capacity part green sheet mentioned above was formed by laminating an expected number of capacity part green sheets, and the green sheet for the outer layer was formed by laminating an expected number of green sheets for the outer layer. The carrier films were peeled off whenever laminating was performed.

Herein, the number of the laminated layers of the capacity part green sheets in the present example was 200. Subsequently, the green sheets for the outer layer laminated with an expected number of pieces were laminated on the upper and lower surfaces of the capacity part green sheet and then hot-pressed, thereby a substrate before firing and before cutting was obtained. In the present example, the outer layer part was formed to be about 50 μm in thickness.

The obtained substrate mentioned above was cut by press-cutting method, and thereby a green laminated body was obtained.

Then, in order to carbonize and burn the organic ingredient of the laminated body, heat-treatment for binder removal was performed. The condition for the binder removal was set such that a holding temperature was 800° C. and a holding time was 12 hours in a humidified mixed gas of nitrogen and hydrogen in which the concentration of hydrogen is 4.0%. The heating rate was not particularly limited, and binder removal process was performed until the residual carbon became 0.1 mass % or less.

The obtained sample bodies after binder removal were fired under the conditions in which the heating rate was 7000° C./h, the holding temperature was 1160° C., the holding time was 10 minutes, and the atmosphere of firing is in the humidified mixed gas of nitrogen and hydrogen with an oxygen partial pressure of 10⁻¹¹ atm.

The laminated body sintered as such was then performed with a reoxidizing process. The reoxidizing process was carried out in a batch furnace in an atmosphere controlled to be 10⁻⁵ atm in which nitrogen and hydrogen coexisted in the present example. In addition, the holding temperature was set to be 950° C.

For the obtained laminated body, end surface polishing was performed using barrel polishing, and the paste for Cu terminal electrode was fused to form terminal electrodes, thereby a laminated ceramic capacitor was manufactured.

### Comparative Examples

### Comparative Example 1

The second ceramic parts are manufactured such that the composition of the ceramic paste for the step absorbing layers was the same as that of the paste for dielectric ceramic layers. The manufacturing method of the laminated ceramic capacitor was similar to the Example except for the composition. In addition, as for the firing condition, a holding temperature of 1190° C. and the holding time of 10 min under 10000° C./h were set.

### Comparative Example 2

A laminated ceramic capacitor in which the thickness of the dielectric ceramic layers was thicken with respect to Comparative Example 1 was manufactured. The composition and the manufacturing method of the laminated ceramic capacitor except the thickness of the dielectric ceramic layers were similar to Example.

### Comparative Example 3

As for the composition of the ceramic paste for the step absorbing layers, CaZrO₃ powders of 50 nm were used as a main component particle, and Ba—Ca—Si glass and Y₂O₃ were added as sintering agents. As the ratio of the components, Y is 0.8 mol, Si is 1.3 mol, Ba is 0.7 mol, and Ca is 0.5 mol relative to 100 mol of CaZrO₃. The Ba—Ca—Si glass was prepared as glass tiny powders by mixing, pulverizing, and prefiring SiO₂, BaCO₃, and CaCO₃. The manufacturing method of the laminated ceramic capacitor was similar to Example except that the change in the composition of the ceramic paste for the step absorbing layers for forming the second ceramic parts. In addition, as for the firing condition, a holding temperature of 1190° C. and the holding time of 10 min under 10000° C./h were set.

(Evaluation of the Laminated Ceramic Capacitor)

The obtained laminated ceramic capacitors were evaluated by the following methods on the thickness of the dielectric ceramic layers, the connecting phase with the end parts of the internal electrode layers, identification for the main ingredient of the second ceramic parts, the composition of the second ceramic part, the number of short circuits, the number of poor insulations and the value of the breakdown voltage.

(Evaluation of the Thickness of the Dielectric Ceramic Layers)

The cross section of the samples obtained was observed using a field emission scanning electron microscope (FE-SEM) at a magnification of 2500 times to evaluate the thickness of the dielectric ceramic layers.

(The Connecting Phase with the End Parts of the Internal Electrode Layers)

The obtained samples were imbedded into the resin and polished such that only internal electrode layers and the second ceramic parts were exposed. EPMA (Electron Probe X-ray Microanalysis) analysis was performed for the polished surfaces. The evaluation was performed under the conditions in which visual field was chosen such that the end parts of the internal electrodes and the second ceramic parts fell into the observation field and an accelerating voltage of 15 kV and an irradiated current of 0.3 μA is performed for a square area of 100 μm×100 μm and the mapping analysis was done.

(Identification for the Main Ingredient of the Second Ceramic Parts)

The obtained samples were imbedded into the resin and polished such that only the second ceramic parts were exposed. EPMA (Electron Probe X-ray Microanalysis) analysis was performed for the polished surface. The evaluation was performed under the conditions in which visual field was chosen such that the end parts of the internal electrodes and the second ceramic parts fell into the observation field and an accelerating voltage of 15 kV and an irradiated current of 0.1 μA is performed for a square area of 30.72 μm×30.72 μm and the mapping analysis was done.

(Identification for the Composition of the Second Ceramic Parts)

The obtained samples were imbedded into the resin and polished such that only the second ceramic parts were exposed. The polished surface was further milled on the surface using an ion milling apparatus. The second ceramic parts of the samples washed by ultrasonic wave and exposed were performed with a quantitative analysis using EPMA (Electron Probe X-ray Microanalysis). In the quantitative analysis, samples which were formed by sintering the powders of Sample 1 to Sample 19 were prepared as the standard samples. The evaluation was performed under the conditions in which visual field was chosen such that the end parts of the internal electrodes and the second ceramic parts fell into the observation field and an accelerating voltage of 15 kV and an irradiated current of 0.1 μA is performed for a square area of 30.72 μm×30.72 μm and the mapping analysis was done.

(The Rate of Short Circuit)

The proportion of the number of the products with a short circuit in the laminated ceramic capacitors to the predetermined number of samples obtained was calculated. The rate of short circuit was obtained by the following methods. The resistances of the laminated ceramic capacitor samples were measured by a tester (CDM-2000D), and the sample of which the resistance was 100Ω or less was judged as a defective product. Then, the rate of short circuit was calculated from 100 samples.

(The Rate of Poor Insulation)

As for each 40 chips of laminated ceramic capacitors without short circuit obtained in the evaluation of the rate of short circuit mentioned above, resistances under the room temperature (25° C.) were measured using ULTRA HIGH RESISTANCE METER (produced by ADVANTEST Corporation, R8340) and applying a direct voltage of 1V for 1 min. The samples with resistances of 10⁶Ω or less were judged as products of poor insulation.

(The Value of the Breakdown Voltage)

To the samples of the laminated ceramic capacitors which were not products of poor insulation obtained in the evaluation of the rate of poor insulation mentioned above, a direct voltage of 10V/sec was applied at a temperature of 25° C. The voltage value relative to the thickness of the dielectric ceramic layers (the unit was V/μm) when the current of 10 mA flowed was deemed as the value of the breakdown voltage. Voltage resistances of the capacitor samples were measured by measuring the breakdown voltage. In addition, the breakdown voltages of 20 laminated ceramic capacitor samples were measured and the average number thereof was used as the breakdown voltage.

As for Sample 1 to Sample 19 of the present examples, the thicknesses of the dielectric ceramic layers of all of the samples were confirmed to be 0.5 μm or less from the results observed by FE-SEM.

As for Sample 1 to Sample 19 of the present examples, it was confirmed that the end parts of the internal electrode layers of all the samples were connected with the second ceramic parts from the results evaluated by EPMA mapping.

As for Sample 1 to Sample 19 of the present examples, it was confirmed that in the second ceramic part of all the samples, the Al—O single phase was the main component in the field of mapping view from the results evaluated by EPMA mapping.

As for Sample 1 to Sample 19 of the present examples, as the analysis results of the compositions of the second ceramic parts obtained by EPMA, the content of Al possessed in the second ceramic parts and the content of Si relative to Al were shown in table 2.

The results of the rate of short circuit, the rate of poor insulation, and the value of the breakdown voltage of Sample 1 to Sample 19 of the present examples and Comparative Examples were shown in table 2.

TABLE 2

| | Thickness of | The content of Al | | | | The value of the |
|---|---|---|---|---|---|---|
| | the dielectric | of the second | The content of Si of | The rate of | The rate of poor | breakdown |
| | ceramic layers | ceramic part | the second ceramic | short circuit | insulation | voltage |
| | (μm) | (mol %) | part (vs Al: 100 mol) | ×/100 | ×/40 | V/μm |
| Sample 1 | 0.42 | 92 | 4 | 15 | 5 | 168 |
| Sample 2 | 0.42 | 83 | 4 | 13 | 4 | 172 |
| Sample 3 | 0.42 | 82 | 21 | 6 | 3 | 198 |
| Sample 4 | 0.42 | 80 | 10 | 1 | 2 | 190 |
| Sample 5 | 0.42 | 78 | 23 | 1 | 0 | 208 |
| Sample 6 | 0.42 | 77 | 25 | 0 | 0 | 206 |
| Sample 7 | 0.42 | 72 | 18 | 0 | 0 | 210 |
| Sample 8 | 0.42 | 68 | 23 | 0 | 0 | 224 |
| Sample 9 | 0.42 | 66 | 40 | 0 | 0 | 223 |
| Sample 10 | 0.42 | 65 | 16 | 0 | 0 | 203 |
| Sample 11 | 0.42 | 65 | 23 | 0 | 0 | 225 |
| Sample 12 | 0.42 | 60 | 40 | 0 | 2 | 221 |
| Sample 13 | 0.42 | 57 | 30 | 3 | 0 | 190 |
| Sample 14 | 0.42 | 45 | 46 | 10 | 8 | 180 |
| Sample 15 | 0.42 | 40 | 90 | 4 | 3 | 171 |
| Sample 16 | 0.42 | 40 | 24 | 2 | 2 | 186 |
| Sample 17 | 0.42 | 40 | 8 | 14 | 7 | 160 |
| Sample 18 | 0.42 | 40 | 93 | 5 | 8 | 162 |
| Sample 19 | 0.42 | 38 | 28 | 6 | 3 | 157 |
| Comparative | 0.42 | — | — | 100 | — | — |
| Example 1 | | | | | | |
| Comparative | 0.55 | — | — | 55 | 12 | 112 |
| Example 2 | | | | | | |
| Comparative | 0.42 | — | — | 100 | — | — |
| Example 3 | | | | | | |

As shown in Table 2, with the second ceramic parts having alumina as a main ingredient, the rate of short-circuit was greatly decreased and the poor insulation rate was also decreased and the value of the breakdown voltage was improved as well as compared to the samples in which the second ceramic parts had the same composition as the first ceramic parts or the samples in which the second ceramic parts were calcium zirconate which were the related art.

The effect of the present invention was as following. With the second ceramic parts being alumina, end parts of the internal electrode layer in the laminated body was spheroidized, dielectric ceramic layers which were partly thinned had a strong combining energy with oxygen and were partly composed of alumina. Therefore, a great reducing property was given to the dielectric ceramic layer which was thinned partly, the poor insulation was greatly improved and the value of the breakdown voltage was also increased.

In addition, as for Comparative Example 1 and Comparative Example 3, the thickness of the dielectric ceramic layer was 0.5 μm or less, and all of them turned to be short circuit, and thus the thickness of the dielectric ceramic layer in Comparative Example 2 was made to be 0.5 μm or more. However, in Sample 1 to Sample 10 of the Examples of the present invention, the rate of short circuit and the breakdown voltage were greatly improved even compared to Comparative Example 2 with a sample of 0.5 μm or more.

Moreover, It can be known from the evaluation results of Sample 4 to Sample 16, the rate of short circuit and the rate of poor insulation were decreased further by controlling the content of Si within the range of the present invention. In addition, the value of the breakdown voltage was also improved.

Further, since the content of Si influenced the composition of the glass ingredient constituting the grain boundary of the ceramic particles, if the content of Si was too much, the ratio of the main component of alumina decreased and the rate of poor insulation increased. If the content of Si was too little, the glass ingredient at the grain boundary component of the sintered ceramic particles might be decreased, and thus good breakdown field intensity could not be maintained. As a result, an optimal content of Si existed in the second ceramic parts containing alumina.

As stated above, the rate of short circuit, the rate of poor insulation and the breakdown field intensity might be greatly improved by using alumina as a main ingredient of the second ceramic parts even if the thickness of the dielectric ceramic layer was 0.5 μm or less.

In the laminated ceramic capacitor of the present invention, the short circuit and the poor insulation are inhibited and a high value of the breakdown voltage is further ensured even if the thickness of the dielectric ceramic layer is extremely thinned. Therefore, it is very useful as a component for the step absorbing layers of a thin multilayered laminated ceramic capacitor. The laminated ceramic capacitor of the present invention can obtain a high capacitance. Thus, it can be used in many purposes such as decoupling purpose, wave-forming purpose, filter purpose, smoothing purpose, and bypass purpose.

### DESCRIPTION OF REFERENCE NUMERALS

1 . . . the first ceramic part (dielectric ceramic layer)
2 . . . the internal electrode layer
3 . . . the laminated body
4 . . . the external electrode
5 . . . the second ceramic part
6 . . . the spheroidized end part of the internal electrode layer
10 . . . the laminated ceramic capacitor
11 . . . the dielectric ceramic green sheet
12 . . . the internal electrode green layer
13 . . . the step absorbing ceramic green layers
14 . . . the carrier film
20 . . . the capacity part green sheet

1. A laminate-type ceramic electronic component, which is a laminated body having a laminated structure formed by laminating first ceramic parts comprising ABO₃ as a main ingredient and internal electrode layers alternately, and has external electrodes which are connected with the internal electrodes,
wherein the end edge parts of the internal electrode layers other than the end connected with said external electrode are connected with the second ceramic parts, and said second ceramic parts contain aluminum oxide as a main ingredient, and
wherein ABO₃ represents a perovskite-type crystal in which site A contains at least Ba and site B contains at least Ti.

2. The laminate-type ceramic electronic component according to claim 1, wherein,
the content of Al contained in said second ceramic parts is in a range of 40 mol % or more and 80 mol % or less in the metal elements constituting said second ceramic parts, and at least one of the elements selected from the group consisting of Si, Ti, Zr, Ce, Ba, Ca, Y, and Mg is contained as the auxiliary ingredients.

3. The laminate-type ceramic electronic component according to claim 1, wherein,
the Si which is contained as the auxiliary ingredient of said second ceramic parts is contained in a range of 10 mol or more and 90 mol or less relative to 100 mol of the main ingredient of Al.

4. The laminate-type ceramic electronic component according to claim 2, wherein,
the Si which is contained as the auxiliary ingredient of said second ceramic parts is contained in a range of 10 mol or more and 90 mol or less relative to 100 mol of the main ingredient of Al.
